(19) United States
(12) Patent Application Publication
(10) Pub. No.: US 2022/0377541 A1
(43) Pub. Date: Nov. 24, 2022

(54) Key Management Method and Communication Apparatus

(71) Applicant: Huawei Technologies Co., Ltd., Shenzhen (CN)

(72) Inventors: Haiyan Luo, Shenzhen (CN); Qinghai Zeng, Shanghai (CN); Mingzeng Dai, Shenzhen (CN)

(21) Appl. No.: 17/882,038

(22) Filed: Aug. 5, 2022

Related U.S. Application Data
(63) Continuation of application No. PCT/CN2020/074439, filed on Feb. 6, 2020.

(51) Int. Cl. H04W 12/0433; H04W 12/041; H04W 12/63

(52) U.S. Cl. CPC H04W 12/0433; H04W 12/041; H04W 12/63

(57) ABSTRACT

A key management method and a communication apparatus is disclosed. The method includes receiving, by a first radio access network (RAN) device, a key parameter and an identifier of a target terminal device sent by a first terminal device, performing at least one of encryption or decryption on transmission data related to communication between the first terminal device and the target terminal device based on the key parameter, and sending, by the first RAN device, the key parameter and an identifier of the first terminal device to the target terminal device.

### CROSS-REFERENCE TO RELATED APPLICATIONS

This application is a continuation of International Application No. PCT/CN2020/074439, filed on Feb. 6, 2020, the disclosure of which is hereby incorporated by reference in its entirety.

### TECHNICAL FIELD

This application relates to the field of mobile communication technologies, and in particular, to a key management method and a communication apparatus.

### BACKGROUND

Currently, terminal devices may communicate with each other through radio access network (RAN) local switch instead of using a core network. In a RAN local switch scenario, user plane data encryption performed by a terminal device is mainly completed by an end-to-end packet data convergence protocol (PDCP) layer of the terminal device, and a base station may not participate in the user plane data encryption.

In current technologies, all terminal devices in a same terminal device group generate a session group key based on a same key parameter provided by a core network, and then use the session group key to encrypt end-to-end data of the terminal devices. This causes the following problem. Once a key parameter of any terminal device in the terminal device group is decrypted, key parameters of all the terminal devices in the terminal device group are decrypted. This poses a serious threat to data security. In the current technologies, there is a problem of low data security when terminal devices communicate with each other through RAN local switch.

### SUMMARY

This application provides a key management method and a communication apparatus, to resolve a problem of low data security when terminal devices communicate with each other through RAN local switch.

According to a first aspect, an embodiment of this application provides a key management method, including a first RAN device receives a key parameter and an identifier of a target terminal device that are sent by a first terminal device. The key parameter is used to encrypt and/or decrypt transmission data when the first terminal device and the target terminal device communicate with each other. The first RAN device sends the key parameter and an identifier of the first terminal device to the target terminal device.

In this embodiment of this application, the first RAN device receives the key parameter and the identifier of the target terminal device from the first terminal device, and then switches the key parameter to the target terminal device, so that both the first terminal device and the target terminal device can encrypt/decrypt data based on the key parameter, to ensure communication reliability. In addition, because the key parameter is provided by the first terminal device, this is different from current technologies in which all terminal devices encrypt/decrypt data by using a same key parameter configured by a core network. Therefore, a problem that key parameters of all terminal devices in a terminal device group are decrypted because a key parameter of any terminal device in the terminal device group is decrypted can be avoided, thereby improving data security.

In a possible implementation, the target terminal device is located in a coverage area of the first RAN device. In this case, the first RAN device may directly switch, to the target terminal device, the key parameter sent by the first terminal device.

In this implementation, both the target terminal device and the first terminal device can encrypt/decrypt data based on the key parameter, to ensure communication reliability.

In a possible implementation, the target terminal device is located in a coverage area of a second RAN device. In this case, the first RAN device may send the key parameter and the identifier of the first terminal device to the target terminal device by using the second RAN device.

In this implementation, both the target terminal device and the first terminal device can encrypt/decrypt data based on the key parameter, to ensure communication reliability.

In a possible implementation, the first terminal device communicates with the first RAN device by using a first protocol stack, the target terminal device communicates with the first RAN device by using the first protocol stack, and an end-to-end second protocol stack exists between the first terminal device and the target terminal device. The first protocol stack includes a physical PHY layer, a media access control MAC layer, and a radio link control RLC layer, and the second protocol stack includes a packet data convergence protocol PDCP layer, a service data adaptation protocol SDAP layer, an RLC layer, and a MAC layer.

In this implementation, it can be ensured that the first terminal device and the target terminal device can communicate with the first RAN device by using the second protocol stack, and the first terminal device can communicate with the target terminal device based on the second protocol stack, to implement RAN local switch.

In a possible implementation, the first terminal device is a communication initiator, and the target terminal device is a communication receiver, or the target terminal device is a communication initiator, and the first terminal device is a communication receiver.

In this implementation, it can be ensured that both the first terminal device and the target terminal device encrypt/decrypt data by using a key parameter provided by the communication initiator or the communication receiver, to ensure communication reliability.

In a possible implementation, the key parameter is a parameter required for the first terminal device and the target terminal device to separately generate a session key, for example, a count.

In this implementation, the parameter required for generating the session key is transmitted, so that the key can be prevented from being directly transmitted, thereby improving security of the key.

In a possible implementation, the foregoing transmission process may be implemented by using a control plane transmission solution. For example, the first RAN device may receive the key parameter and the identifier of the target terminal device that are sent by the first terminal device by using an uplink RRC message. When both the first terminal device and the target terminal device are located in the coverage area of the first RAN device, the first RAN device may send the key parameter and the identifier of the first terminal device to the target terminal device by using a downlink RRC message. When the first terminal device is located in the coverage area of the first RAN device, for example, when the target terminal device is located in the coverage area of the second RAN device, the first RAN device may send the key parameter, the identifier of the first terminal device, and the identifier of the target terminal device to the second RAN device by using an interface message between the first RAN device and the second RAN device. Then, the second RAN device sends the key parameter and the identifier of the first terminal device to the target terminal device by using the downlink RRC message.

In this implementation, transmission of the key parameter and the like can be implemented by using the control plane transmission solution, to ensure reliability of the solution.

In a possible implementation, the foregoing transmission process may be implemented by using a data user plane transmission solution. For example, the first RAN device may receive first data sent by the first terminal device, where an encapsulation header encapsulated outside the first data includes the key parameter and the identifier of the target terminal device. When both the first terminal device and the target terminal device are located in the coverage area of the first RAN device, the first RAN device may directly send second data to the target terminal device. An encapsulation header outside the second data includes the key parameter and the identifier of the first terminal device. It should be understood that the first data and the second data herein are essentially same data, and are payload data. When the first terminal device is located in the coverage area of the first RAN device, for example, when the target terminal device is located in the coverage area of the second RAN device, the first RAN device may send a data packet encapsulated by a GTP-U to the second RAN device. A packet header of the data packet encapsulated by the GTP-U carries the key parameter, the identifier of the first terminal device, and the identifier of the target terminal device, and the data packet encapsulated by the GTP-U includes the first data. Then, the second RAN device sends third data to the target terminal device. An encapsulation header outside the third data includes the key parameter and the identifier of the first terminal device. It should be understood that the first data and the third data herein are essentially same data, and are payload data.

In this implementation, transmission of the key parameter and the like can be implemented by using the user plane transmission solution, to ensure reliability of the solution.

In a possible implementation, the encapsulation header of the first data further includes a network slice identifier slice ID and/or a quality of service QoS flow identifier QFI of the target terminal device.

In this implementation, when the first RAN device sends the key parameter and the identifier of the first terminal device to the target terminal device, the first RAN device quickly determines a DRB of the target terminal device based on the slice ID and/or the QoS flow identifier QFI of the target terminal device, to ensure communication efficiency.

In a possible implementation, the data packet encapsulated by the GTP-U may further carry the slice ID and/or the QFI of the target terminal device.

In this implementation, when the second RAN device sends the key parameter and the identifier of the first terminal device to the target terminal device, the first RAN device quickly determines the DRB of the target terminal device based on the slice ID and/or the QoS flow identifier QFI of the target terminal device, to ensure communication efficiency.

In a possible implementation, the target terminal device may be a single device, for example, the second terminal device. In this case, the identifier of the target terminal is a first identifier of the second terminal device. Before the first RAN device sends the key parameter and the identifier of the first terminal device to the target terminal device, the first RAN device further determines a second identifier of the second terminal device based on the first identifier of the second terminal device. The first identifier includes a device identifier, for example, an IP address, a MAC address, or an identifier of the first terminal device in a terminal device group to which the first terminal device belongs, and the second identifier includes a cell radio network temporary identifier C-RNTI. Then, the first RAN device sends the key parameter and the identifier of the first terminal device to the second terminal device based on the second identifier of the second terminal device.

In this implementation, the first RAN device may determine the cell radio network temporary identifier C-RNTI of the second terminal device based on the device identifier of the second terminal device, and then send the key parameter and the identifier of the first terminal device to the second network device based on the C-RNTI, to ensure communication efficiency.

In a possible implementation, the target terminal device may be a terminal device group (for example, the terminal device group to which the first terminal device belongs). In this case, the identifier of the target terminal device includes a group identifier of the terminal device group to which the first terminal device belongs. Correspondingly, the first RAN device sends the key parameter and the identifier of the first terminal device to the terminal device group through a multicast channel. The multicast channel corresponds to the terminal device group.

In this implementation, the first terminal device may provide the key parameter for the entire terminal device group by using the first RAN device, to implement multicast communication.

In a possible implementation, the key parameter may be an initial key parameter allocated by a core network to the first terminal device, or a key parameter obtained by the first terminal device based on the initial key parameter allocated by the core network.

In this implementation, key parameters of different terminal devices in the terminal device group may be different, so that different terminal device pairs communicate with each other by using different session keys, thereby ensuring security of data for RAN local switch.

According to a second aspect, an embodiment of this application provides a key management method, including a first terminal device determines a key parameter and an identifier of a target terminal device. The key parameter is used to encrypt and/or decrypt transmission data when the first terminal device and the target terminal device communicate with each other. The first terminal device sends the key parameter and the identifier of the target terminal device to a first radio access network RAN device.

In a possible implementation, the target terminal device is located in a coverage area of the first RAN device.

In a possible implementation, the target terminal device is located in a coverage area of a second RAN device.

In a possible implementation, the first terminal device communicates with the first RAN device by using a first protocol stack, the target terminal device communicates with the first RAN device by using the first protocol stack, and an end-to-end second protocol stack exists between the first terminal device and the target terminal device. The first protocol stack includes a physical PHY layer, a media access control MAC layer, and a radio link control RLC layer, and the second protocol stack includes a packet data convergence protocol PDCP layer, a service data adaptation protocol SDAP layer, an RLC layer, and a MAC layer.

In a possible implementation, the key parameter is a parameter required for the first terminal device and the target terminal device to separately generate a session key.

In a possible implementation, that the first terminal device sends the key parameter and the identifier of the target terminal device to a first radio access network RAN device includes the first terminal device sends first data to the first radio access network RAN device. An encapsulation header encapsulated outside the first data includes the key parameter and the identifier of the target terminal device.

In a possible implementation, the identifier of the target terminal device includes a first identifier of a second terminal device, and the first identifier includes a device identifier.

In a possible implementation, the identifier of the target terminal device includes a group identifier of a terminal device group to which the first terminal device belongs.

According to a third aspect, an embodiment of this application provides a key management method, including a second RAN device receives a key parameter, an identifier of a first terminal device, and an identifier of a target terminal device that are sent by a first RAN device. The key parameter is used to encrypt and/or decrypt transmission data when the first terminal device and the target terminal device communicate with each other. The second RAN device sends the key parameter and the identifier of the first terminal device to the target terminal device.

In a possible implementation, the target terminal device communicates with the second RAN device by using a first protocol stack, and an end-to-end second protocol stack exists between the first terminal device and the target terminal device. The first protocol stack includes a physical PHY layer, a media access control MAC layer, and a radio link control RLC layer, and the second protocol stack includes a packet data convergence protocol PDCP layer, a service data adaptation protocol SDAP layer, an RLC layer, and a MAC layer.

In a possible implementation, the key parameter is a parameter required for the first terminal device and the target terminal device to separately generate a session key.

In a possible implementation, that a second RAN device receives a key parameter, an identifier of a first terminal device, and an identifier of a target terminal device that are sent by a first RAN device includes the second RAN device receives a data packet encapsulated by a general packet radio service tunneling protocol-user plane GTP-U sent by the first RAN device. A packet header of the data packet encapsulated by the GTP-U carries the key parameter, the identifier of the first terminal device, and the identifier of the target terminal device.

In a possible implementation, that the second RAN device sends the key parameter and the identifier of the first terminal device to the target terminal device includes the second RAN device sends third data to the target terminal device. An encapsulation header outside the third data includes the key parameter and the identifier of the first terminal device.

In a possible implementation, the identifier of the target terminal device includes a first identifier of a second terminal device. Before that the second RAN device sends the key parameter and the identifier of the first terminal device to the target terminal device, the method further includes the second RAN device determines a second identifier of the second terminal device based on the first identifier of the second terminal device. The first identifier includes a device identifier, and the second identifier includes a cell radio network temporary identifier C-RNTI. That the second RAN device sends the key parameter and the identifier of the first terminal device to the target terminal device includes the second RAN device sends the key parameter and the identifier of the first terminal device to the second terminal device based on the second identifier of the second terminal device.

In a possible implementation, the identifier of the target terminal device includes a group identifier of a terminal device group to which the first terminal device belongs. That the second RAN device sends the key parameter and the identifier of the first terminal device to the target terminal device includes the second RAN device sends the key parameter and the identifier of the first terminal device to the terminal device group through a multicast channel. The multicast channel corresponds to the terminal device group.

According to a fourth aspect, an embodiment of this application provides a key management method, including a target terminal device receives a key parameter and an identifier of a first terminal device that are sent by a first RAN device or a second RAN device. The target terminal device and the first terminal device encrypt and/or decrypt transmission data by using the key parameter when communicating with each other.

According to a fifth aspect, an embodiment of this application provides a communication apparatus. The apparatus may be the first RAN device in the first aspect, or an apparatus in the first RAN device. The apparatus includes modules configured to perform the method according to any one of the possible implementations of the first aspect. For example, a receiving module is configured to receive a key parameter and an identifier of a target terminal device that are sent by a first terminal device, where the key parameter is used to encrypt and/or decrypt transmission data when the first terminal device and the target terminal device communicate with each other, and a sending module is configured to send the key parameter and an identifier of the first terminal device to the target terminal device.

According to a sixth aspect, an embodiment of this application provides a communication apparatus. The apparatus may be the first terminal device in the second aspect, or an apparatus in the first terminal device. The apparatus includes modules configured to perform the method according to any one of the possible implementations of the second aspect. For example, a processing module is configured to determine a key parameter and an identifier of a target terminal device, where the key parameter is used to encrypt and/or decrypt transmission data when the first terminal device and the target terminal device communicate with each other, and a sending module is configured to send the key parameter and the identifier of the target terminal device to a first radio access network RAN device.

According to a seventh aspect, an embodiment of this application provides a communication apparatus. The apparatus may be the second RAN device in the third aspect, or an apparatus in the second RAN device. The apparatus includes modules configured to perform the method according to any one of the possible implementations of the third aspect. For example, a receiving module is configured to receive a key parameter, an identifier of a first terminal device, and an identifier of a target terminal device that are sent by a first RAN device, where the key parameter is used to encrypt and/or decrypt transmission data when the first terminal device and the target terminal device communicate with each other, and a sending module is configured to send the key parameter and the identifier of the first terminal device to the target terminal device.

According to an eighth aspect, an embodiment of this application provides a communication apparatus. The apparatus may be the target terminal device in the fourth aspect, or an apparatus in the target terminal device. The apparatus includes modules configured to perform the method according to any one of the possible implementations of the fourth aspect. For example, a receiving module is configured to receive a key parameter and an identifier of a first terminal device that are sent by a first RAN device or a second RAN device, and a processing module is configured to encrypt and/or decrypt transmission data by using the key parameter when the first terminal device and the target terminal device communicate with each other.

According to a ninth aspect, an embodiment of this application provides a communication apparatus, including at least one processor, and a memory and/or a communication interface that are/is communicatively connected to the at least one processor. The memory stores instructions that can be executed by the at least one processor, and the at least one processor executes the instructions stored in the memory, to perform the method according to any one of the possible implementations of the first aspect, the second aspect, the third aspect, or the fourth aspect.

According to a tenth aspect, an embodiment of this application provides a computer-readable storage medium. The computer-readable storage medium stores a computer program. The computer program includes program instructions. When the program instructions are executed by a computer, the computer is enabled to perform the method according to any one of the possible implementations of the first aspect, the second aspect, the third aspect, or the fourth aspect.

According to an eleventh aspect, an embodiment of this application provides a chip. The chip is coupled to a memory, and is configured to read and execute program instructions stored in the memory, to implement the method according to any one of the possible implementations of the first aspect, the second aspect, the third aspect, or the fourth aspect.

### BRIEF DESCRIPTION OF THE DRAWINGS

FIG. 1 is a schematic diagram of a network architecture of a current NR system;

FIG. 2 is a flowchart in which a core network provides a key parameter for a terminal device 1;

FIG. 3 is a principle diagram of generating a session group key by a terminal device 1;

FIG. 4A is a schematic diagram of a network architecture to which an embodiment of this application is applicable;

FIG. 4B is a schematic diagram of another network architecture to which an embodiment of this application is applicable;

FIG. 5 is a flowchart of a key management method according to an embodiment of this application;

FIG. 6A is a schematic diagram of a possible user plane protocol stack;

FIG. 6B is a schematic diagram of another possible user plane protocol stack;

FIG. 6C is a schematic diagram of another possible user plane protocol stack;

FIG. 7 is a flowchart in which UE 1 transmits a count 1 to UE 2 through a control plane when the UE 1 and the UE 2 are co-sited;

FIG. 8 is a flowchart in which UE 1 transmits a count 1 to UE 2 through a user plane when the UE 1 and the UE 2 are co-sited;

FIG. 9 is a flowchart in which UE 1 transmits a count 1 to UE 2 when the UE 1 and the UE 2 are cross-sited;

FIG. 10 is a schematic structural diagram of a communication apparatus 1100 according to an embodiment of this application;

FIG. 11 is a schematic structural diagram of a communication apparatus 1200 according to an embodiment of this application;

FIG. 12 is a schematic structural diagram of a communication apparatus 1300 according to an embodiment of this application;

FIG. 13 is a schematic structural diagram of a communication apparatus 1400 according to an embodiment of this application; and

FIG. 14 is a schematic structural diagram of a communication apparatus 1500 according to an embodiment of this application.

### DETAILED DESCRIPTION OF ILLUSTRATIVE EMBODIMENTS

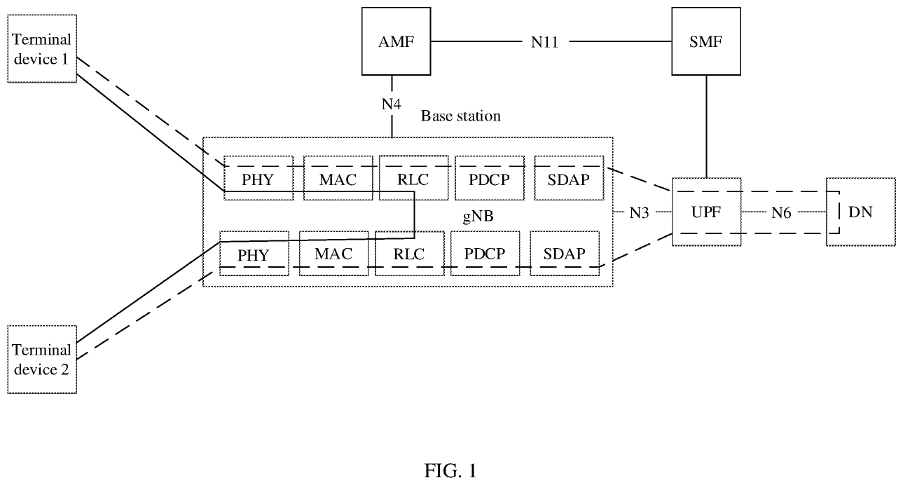

FIG. 1 is a schematic diagram of a network architecture of a current new radio (NR) system. As shown in FIG. 1, the NR system includes a next generation NodeB (gNB) on a radio access network (RAN) side, an access and mobility management function (AMF) network element, a session management function (SMF) network element, a user plane function (UPF) network element, and a data network (DN) network element on a core network (CN) side, and the like.

If a terminal device 1 communicates with a terminal device 2, a conventional method is shown by a dashed line in FIG. 1. Data of the terminal device 1 first passes through a RAN, then arrives at the UPF in a core network, then arrives at the DN, and finally arrives at the terminal device 2 by sequentially passing through the UPF and the RAN. The UPF may be at a high location, for example, near the DN. Alternatively, the UPF may be at a low location, for example, near the RAN. A shorter distance between the UPF and the RAN indicates a lower data transmission latency.

In the NR system, a communication path between the terminal device 1 and the terminal device 2 may not pass through the DN, the UPF, and the like, for example, a path represented by a solid line in FIG. 1. The data of the terminal device 1 may be switched to the terminal device 2 by passing through only a physical (PHY) layer, a media access control (MAC) layer, and a radio link control (RLC) layer on the RAN network side. The foregoing method for directly performing local switch by using a part of a protocol stack of a base station may be referred to as RAN local switch, or referred to as RLC based local switch. It should be understood that the RAN herein may be one base station, in other words, the terminal device 1 and the terminal device 2 are in a coverage area of a same base station. Alternatively, the RAN herein may be a plurality of base stations, in other words, the terminal device 1 and the terminal device 2 are respectively in coverage areas of different base stations. For example, the terminal device 1 corresponds to a base station 1, and the terminal device 2 corresponds to a base station 2. In this case, a data transmission path is the terminal device 1→the base station 1→the base station 2→the terminal device 2.

When the terminal device 1 and the terminal device 2 perform data transmission through RAN local switch, user plane data encryption is mainly completed by an end-to-end packet data convergence protocol (PDCP) layer of the terminal device 1 and the terminal device 2, and the gNB does not participate in the user plane data encryption. Specifically, the terminal device 1 and the terminal device 2 belong to a same terminal device group. Each terminal device in the terminal device group generates a public base key, a session group key based on a key parameter provided by the core network, and encrypts data by using the generated session group key.

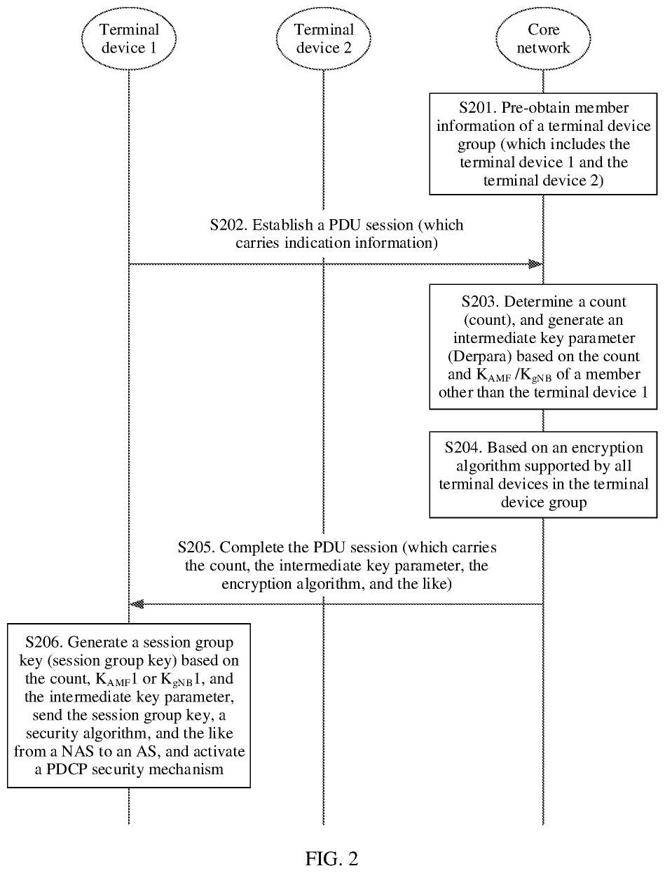

The core network may provide the key parameter for the terminal device 1 in a process in which the terminal device 1 requests a PDU session. As shown in FIG. 2, the process includes the following steps.

S201. The core network obtains member information of a terminal device group, for example, the terminal device 1 and the terminal device 2.

S202. The terminal device 1 initiates a request for establishing a PDU session to the core network. The request carries indication information, to indicate RAN local switch, or indicate the core network to configure a key parameter for local switch for the terminal device 1, and the key parameter is, for example, a count.

S203. After receiving the PDU session request sent by the terminal device 1, the core network configures the count (where counts of all terminal devices in the terminal device group are the same), and generates an intermediate key parameter Derpara for the terminal device 1 based on a base station encryption parameter K_{AMF} or K_{gNB} of another member.

Specifically, the core network may generate corresponding Ktemp for each terminal device based on K_{AMF} or K_{gNB} and the count of the terminal device. Because K_{AMF} or K_{gNB} of each terminal device may be different, Ktemp of each terminal device may be different. Then, the core network performs exclusive OR calculation on Ktemp values of all terminal devices other than the terminal device 1, to generate Derpara, or the core network directly performs exclusive OR calculation on K_{AMF} values or K_{gNB} values of all terminal devices other than the terminal device 1, to generate Derpara.

S204. The core network notifies the terminal devices of a selected encryption algorithm based on an encryption algorithm supported by all the terminal devices in the terminal device group.

S205. After establishing the PDU session for the terminal device 1, the core network sends the count value, Derpara, and the encryption algorithm to the terminal device 1.

S206. A non-access stratum (NAS) of the terminal device 1 generates a session group key based on K_{AMF}1 or K_{gNB}1, the count, and Derpara of the terminal device 1, sends the session group key, a security algorithm, and the like to an access stratum (AS), and sends, to the AS, the encryption algorithm indicated by the core network, to activate a PDCP security mechanism, so that the terminal device 1 encrypts/decrypts data based on the session group key and the encryption algorithm when performing end-to-end communication with a member in the terminal device group.

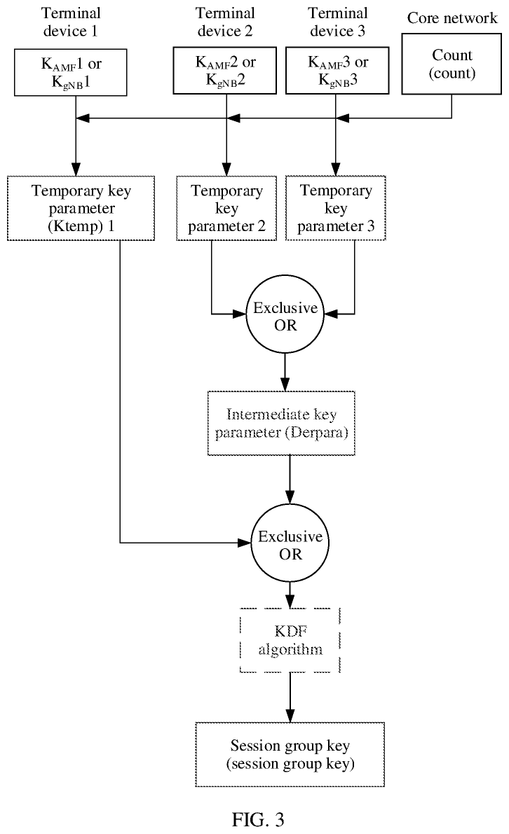

FIG. 3 is a principle diagram of generating the session group key by the terminal device 1. The terminal device 1 performs exclusive OR calculation on a key K_{AMF}1 or K_{gNB}1 of the terminal device 1, an intermediate key parameter (Derpara) generated based on a base station encryption parameter (for example, K_{AMF}2 or K_{gNB}2, and K_{AMF}3 or K_{gNB}3 in FIG. 2) of another terminal device in the terminal device group, and a count provided by the core network to obtain the session group key.

In the foregoing encryption solution, because the count provided by the core network for each terminal device in the terminal device group is a same value, a session group key generated by each terminal device in the terminal device group is the same, and Derpara and the count of each terminal device may be updated (that is, the session group key is updated) only when a new member joins or leaves the terminal device group. This causes the following problem. Once a key parameter, namely, a count of any terminal device in the terminal device group is decrypted, key parameters, namely, counts of all the terminal devices in the terminal device group are decrypted. This poses a serious threat to data security.

Therefore, embodiments of this application provide a key management method. A core network may provide different key parameters (for example, counts) for different terminal devices in a terminal device group, and/or a terminal device updates a key parameter of the terminal device based on mobility of the terminal device. When any terminal device pair in the terminal device group (where for ease of description, two terminal devices that communicate with each other are referred to as a “terminal device pair” in this specification) needs to perform communication, one terminal device (for example, a communication initiator or a communication receiver) in the terminal device pair provides a key parameter of the terminal device to the other terminal device, so that the two terminal devices in the terminal device pair use a same key parameter to generate a session key, and use the same session key to encrypt and decrypt data, to ensure communication reliability. In addition, because different terminal devices may provide different key parameters, different terminal device pairs may use different session keys. Therefore, a problem that key parameters of all terminal devices in the terminal device group are decrypted because a key parameter of any terminal device in the terminal device group is decrypted can be avoided, thereby improving data security.

It should be understood that in this specification, an example in which the key parameter is a count is used. In other words, unless otherwise specified, the key parameter in this specification is the count. In other words, the “key parameter” and the “count” in this specification may be replaced with each other.

Certainly, a name “count” of the key parameter in this specification is merely an example. In specific implementation, the name of the key parameter may be replaced with another name.

Technical solutions in embodiments of this application may be applied to various communication systems, such as a global system for mobile communications (GSM) system, a code division multiple access (CDMA) system, a wideband code division multiple access (WCDMA) system, a general packet radio service (GPRS), a long term evolution (LTE) system, an LTE frequency division duplex (FDD) system, an LTE time division duplex (TDD) system, a universal mobile telecommunications system (UMTS), a worldwide interoperability for microwave access (WiMAX) communication system, a 5th generation (5G) system, for example, NR, and a future communication system, for example, a 6G system. Certainly, the technical solutions in embodiments of this application may also be applied to another communication system.

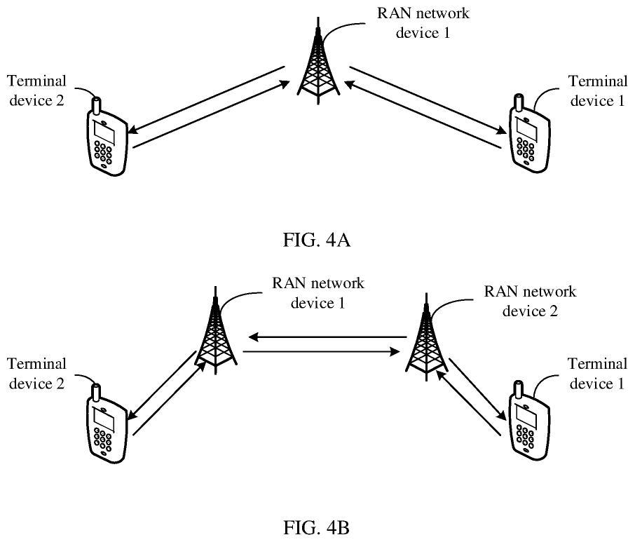

For example, FIG. 4A is a schematic diagram of a network architecture to which an embodiment of this application is applicable. The communication system includes a RAN device 1, a terminal device 1, and a terminal device 2. The terminal device 1 and the terminal device 2 belong to a same terminal device group. Both the terminal device 1 and the terminal device 2 are in a coverage area of the RAN device 1 (in other words, both the terminal device 1 and the terminal device 2 are connected to the RAN device 1). The RAN device 1 may switch data from the terminal device 1 to the terminal device 2, and may also switch data from the terminal device 2 to the terminal device 1.

It should be understood that FIG. 4A shows merely an example of a communication system and does not constitute a limitation. During actual deployment, there may be more RAN devices and terminal devices in the communication system.

For example, FIG. 4B is a schematic diagram of another network architecture to which an embodiment of this application is applicable. The communication system includes a RAN device 1, a RAN device 2, a terminal device 1, and a terminal device 2. The terminal device 1 and the terminal device 2 belong to a same terminal device group. The terminal device 1 is in a coverage area of the RAN device 1 (in other words, the terminal device 1 is connected to the RAN device 1), and the terminal device 2 is in a coverage area of the RAN device 2 (in other words, the terminal device 2 is connected to the RAN device 2). The RAN device 1 and the RAN device 2 may communicate with each other. The RAN device 1 may switch data from the terminal device 1 to the RAN device 2, and then the RAN device 2 switches the data to the terminal device 2. The RAN device 2 may switch data from the terminal device 2 to the RAN device 1, and then the RAN device 1 switches the data to the terminal device 1.

It should be understood that FIG. 4B shows merely an example of a communication system and does not constitute a limitation. During actual deployment, there may be more RAN devices and terminal devices in the communication system. For example, there may be further a RAN device 3 in addition to the RAN device 1 and the RAN device 2. Communication between the RAN device 1 and the RAN device 2 is switched by using the RAN device 3. For example, the communication system may further include a core network device.

The following clearly and completely describes the technical solutions in embodiments of this application with reference to the accompanying drawings in embodiments of this application. Clearly, the described embodiments are merely some but not all of embodiments of this application.

To make embodiments of this application clearer, the following collectively describes again some content and concepts related to embodiments of this application.

A terminal device in embodiments of this application, also referred to as a terminal, is an entity configured to receive or transmit a signal on a user side, and is configured to send an uplink signal to a network device or receive a downlink signal from a network device. The terminal device includes a device that provides a user with voice and/or data connectivity, for example, may include a handheld device having a wireless connection function, or a processing device connected to a wireless modem. The terminal device may communicate with a core network by using a radio access network (RAN), and exchange a voice and/or data with the RAN. The terminal device may include user equipment (UE), a V2X terminal device, a wireless terminal device, a mobile terminal device, a device-to-device (D2D) communication terminal device, a machine-to-machine/machine-type communications (M2M/MTC) terminal device, an internet of things (internet of things, IoT) terminal device, a subscriber unit, a subscriber station, a mobile station, a remote station, an access point (AP), a remote terminal, an access terminal, a user terminal, a user agent, a user device, or the like. For example, the terminal device may include a mobile phone (or referred to as a “cellular” phone), a computer with a mobile terminal device, or a portable, pocket-sized, handheld, or computer built-in mobile apparatus. For example, the terminal device may include a device such as a personal communications service (PCS) phone, a cordless telephone set, a session initiation protocol (SIP) phone, a wireless local loop (WLL) station, or a personal digital assistant (PDA). The terminal device further includes a limited device, for example, a device with low power consumption, a device with a limited storage capability, or a device with a limited computing capability. For example, the terminal device includes an information sensor device such as a barcode, radio frequency identification (RFID), a sensor, a global positioning system (GPS), or a laser scanner.

By way of example and not limitation, in embodiments of this application, the terminal device may alternatively be a wearable device. The wearable device may also be referred to as a wearable intelligent device, an intelligent wearable device, or the like, and is a generic term for wearable devices that are developed by applying wearable technologies to intelligent designs of daily wear, such as glasses, gloves, watches, clothes, and shoes. The wearable device is directly worn, or is a portable device integrated into clothes or an accessory of the user. The wearable device is not only a hardware device, but also implements a powerful function through software support, data exchange, and cloud interaction. In a broad sense, wearable intelligent devices include full-featured and large-sized devices that can implement all or some of functions without depending on smartphones, for example, smart watches or smart glasses, and devices that focus on only one type of application function and that need to cooperate with other devices such as smartphones, for example, various smart bands, smart helmets, or smart jewelries for monitoring physical signs.

If the various terminal devices described above are located in a vehicle (for example, placed in the vehicle or installed in the vehicle), the terminal devices may all be considered as vehicle-mounted terminal devices. For example, the vehicle-mounted terminal device is also referred to as an on-board unit (OBU).

A RAN device in embodiments of this application is a device that is in a communication system and that enables a terminal device to access a radio network. The RAN device is a node in a radio access network, and may also be referred to as a base station or a radio access network device. The RAN device may include an evolved NodeB (eNB or e-NodeB) in a long term evolution (LTE) system or long term evolution-advanced (LTE-A), or may include a next generation NodeB (gNB), a next generation evolved NodeB (ng-eNB), or an enhanced next generation NodeB (en-gNB), namely, an enhanced next generation base station in an NR system in a 5th generation (5G) mobile communication technology.

The RAN device may further include a centralized unit (CU) and a distributed unit (DU) in a cloud access network (Cloud RAN) system, or may further include a relay device. This is not limited in embodiments of this application.

A data network element in embodiments of this application may be the Internet, an IP multimedia service (IMS) network, an area network (namely, a local network, for example, a mobile edge computing (MEC) network), or the like. A data network includes an application server, and the application server provides a service for a terminal device by transmitting data with the terminal device.

An access and mobility management function network element in embodiments of this application may be configured to manage access control and mobility of a terminal device. During actual application, the access and mobility management function network element includes a mobility management function in a mobility management entity (MME) in a network framework in long term evolution (LTE), and includes an access management function. The access and mobility management function network element may be specifically responsible for registration of the terminal device, mobility management, a tracking area update procedure, reachability detection, selection of a session management function network element, mobility status transition management, and so on. For example, in 5G, the access and mobility management function network element may be an access and mobility management function (AMF) network element. In future communication, for example, in 6G, the core network access and mobility management function network element may still be an AMF, or have another name. This is not limited in this application. When the core network access and mobility management function network element is an AMF, the AMF may provide a Namf service.

A user plane function network element in embodiments of this application may be configured to perform packet routing and switching, support an uplink classifier to route a service flow to a data network instance, support a branch point to support a multi-homed packet data unit (PDU) session, perform user plane quality of service (QoS) processing, buffer a downlink data packet, trigger a downlink data notification, and so on. For example, in 5G, the user plane function network element may be a UPF network element. In future communication, for example, in 6G, the user plane function network element may still be a UPF network element, or may have another name. This is not limited in this application.

A session management function network element in embodiments of this application may be responsible for session management (including session establishment, modification, and release) of a terminal device, selection and reselection of a user plane function network element, internet protocol (IP) address allocation and QoS control of the terminal device, and so on. For example, in 5G, the session management function network element is an session management function (SMF) network element. In future communication, for example, in 6G, the session management function network element may still be an SMF network element, or have another name. This is not limited in this application. When the session management function network element is an SMF network element, the SMF may provide an Nsmf service.

Terms “system” and “network” may be used interchangeably in embodiments of this application. A term “a plurality of” may mean two, three, or more. This is not limited in embodiments of this application. A positive integer may be one or more.

In addition, a term “and/or” in this specification describes only an association relationship for describing associated objects and represents that three relationships may exist. For example, A and/or B may represent the following three cases: Only A exists, both A and B exist, and only B exists. In addition, a character “/” in this specification generally indicates an “or” relationship between the associated objects, unless otherwise specified.

Unless otherwise stated, ordinal numerals such as “first”, “second”, “third”, and “fourth” mentioned in embodiments of this application are used to differentiate between a plurality of objects, but not used to limit an order, a time sequence, a priority, or an importance degree of the plurality of objects.

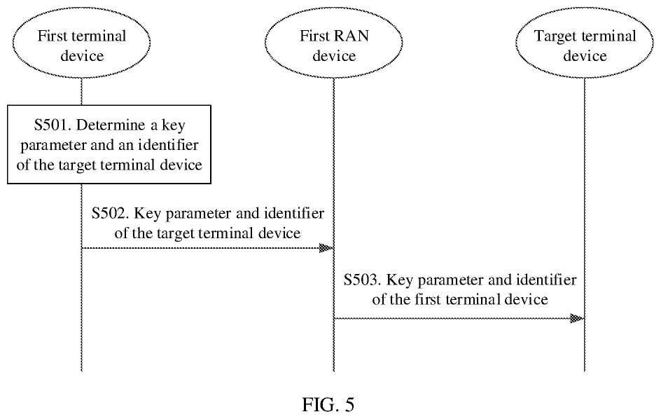

FIG. 5 shows a key management method according to an embodiment of this application. The key management method may be applied to the wireless communication system shown in FIG. 4A or FIG. 4B. Refer to FIG. 5. The method includes the following steps.

S501. A first terminal device determines a key parameter and an identifier of a target terminal device.

S502. The first terminal device sends the key parameter and the identifier of the target terminal device to a first RAN device, and the first RAN device receives the key parameter of the first terminal device and the identifier of the target terminal device.

The key parameter is used to encrypt and/or decrypt transmission data when the first terminal device and the target terminal device communicate with each other.

In this embodiment of this application, the first terminal device may have a plurality of sets of key parameters at the same time. One set of key parameters is a key parameter (used when the first terminal device serves as a transmit end) provided by the first terminal device, and another set of key parameters is a key parameter (used when the first terminal device serves as a receive end) provided by another terminal device for the first terminal device. During specific implementation, the first terminal device sends, to the first RAN device, the key parameter provided by the first terminal device.

In a possible implementation, the first terminal device is a communication initiator, and the target terminal device is a communication receiver. That is, when two terminal devices that communicate with each other need to perform communication, the communication initiator provides the key parameter for the initiator and the receiver to encrypt/decrypt data. In another possible implementation, the target terminal device is a communication initiator, and the first terminal device is a communication receiver. That is, when two terminal devices that communicate with each other need to perform communication, the communication receiver provides the key parameter for the initiator and the receiver to encrypt/decrypt data. In both the foregoing implementations, it can be ensured that the first terminal device and the target terminal device encrypt/decrypt the transmission data by using the same key parameter, thereby ensuring communication reliability. In the following descriptions of this specification, an example in which the first terminal device is a communication initiator is mainly used to describe the technical solutions of this application.

In a possible implementation, the key parameter may be a key or an encrypted key. In this way, after receiving the key parameter, the target terminal device can directly obtain the key, to encrypt/decrypt data, thereby improving communication efficiency.

In a possible implementation, the key parameter may be a parameter required for the first terminal device and the target terminal device to separately generate a session key. In this way, keys generated by the first terminal device and the target terminal device can be the same by transmitting the key parameter, and the key can be prevented from being directly transmitted, thereby improving key security.

For example, the first terminal device and the target terminal device belong to a same terminal device group, the session key is specifically a session group key, and the key parameter is a count count used by the first terminal device and the target terminal device to separately generate the session group key. It should be understood that, in this specification, the session group key is merely an example of the session key. During specific implementation, the session group key may also have another form or name. This is not limited in this embodiment of this application. Similarly, for the key parameter, the count is also merely an example of the key parameter. During specific implementation, the count may also have another form or name. This is not limited in this embodiment of this application.

In a possible implementation, a core network may allocate an initial key parameter (for example, an initial value of the count) to the first terminal device, and the core network allocates different initial key parameters to different terminal devices in a terminal device group to which the first terminal device belongs. In addition, the core network may further configure a corresponding Derpara parameter for each terminal device in the terminal device group.

For example, it is assumed that the terminal device group includes UE 1, UE 2, UE 3, and UE 4, a count 1 is allocated by the core network to the UE 1, a count 2 is allocated by the core network to the UE 2, a count 3 is allocated by the core network to the UE 3, and a count 4 is allocated by the core network to the UE 4. The core network separately configures Derpara 1/Derpara 2/Derpara 3/Derpara 4 for the UE 1, the UE 2, the UE 3, and the UE 4. Derpara 1 is generated based on K_{AMF}2 or K_{gNB}2 of the UE 2, K_{AMF}3 or K_{gNB}3 of the UE 3, and K_{AMF}4 or K_{gNB}4 of the UE 4, Derpara 2 is generated based on K_{AMF}1 or K_{gNB}1 of the UE 1, K_{AMF}3 or K_{gNB}3 of the UE 3, and K_{AMF}4 or K_{gNB}4 of the UE 4, Derpara 3 is generated based on K_{AMF}1 or K_{gNB}1 of the UE 1, K_{AMF}2 or K_{gNB}2 of the UE 2, and K_{AMF}4 or K_{gNB}4 of the UE 4, and Derpara 4 is generated based on K_{AMF}1 or K_{gNB}1 of the UE 1, KK_{AMF}2 or K_{gNB}2 of the UE 2, and K_{AMF}3 or K_{gNB}3 of the UE 3. When the UE 1 subsequently communicates with the UE 2 (the target terminal device), the UE 1 generates a session group key 1 based on K_{AMF}1 or K_{gNB}1 of the UE 1, a key parameter (the count 1) provided by the UE 1, and the Derpara parameter provided by the core network. The UE 2 generates a session group key 2 based on K_{AMF}2 or K_{gNB}2 the UE 2, the key parameter (the count value 1) provided by the UE 1, and the Derpara 2 parameter provided by the core network. Based on the foregoing key generation principle, it can be ensured that the session group key 1 is the same as the session group key 2, thereby ensuring normal communication between the UE 1 and the UE 2.

Similarly, when the UE 3 subsequently communicates with the UE 4 (the target terminal device), the UE 3 generates a session group key 3 based on K_{AMF}3 or K_{gNB}3 of the UE 3, a key parameter (the count 3) provided by the UE 3, and the Derpara parameter provided by the core network. The UE 4 generates a session group key 4 based on K_{AMF}4 or K_{gNB}4 of the UE 4, the key parameter (the count 3) provided by the UE 3, and the Derpara 4 parameter provided by the core network. Based on the key generation principle, it can be ensured that the session group key 3 is the same as the session group key 4, thereby ensuring normal communication between the UE 3 and the UE 4.

In the foregoing method, the session group key used by the UE 1 and the UE 2 for communication may be different from the session group key used by the UE 3 and the UE 4 for communication. In this way, an effect that different terminal device pairs in a same terminal device group can communicate with each other by using different keys can be achieved, and data security can be improved.

In another possible implementation, the first terminal device may obtain the key parameter based on the initial key parameter allocated by the core network. For example, the first terminal device may update the key parameter based on mobility of the first terminal device. For example, when a moving distance of the first terminal device exceeds a threshold (for example, 500 meters), a count value of the first terminal device is increased by 1, or when a base station/cell to which the first terminal device belongs is handed over once, a count value of the first terminal device is increased by 1. In this way, not only key parameters of different terminal device pairs in the terminal device group can be made different, but also a case in which a same terminal device pair uses one key for a long time can be avoided, thereby further improving data security.

S503. The first RAN device sends the key parameter and an identifier of the first terminal device to the target terminal device.

Specifically, after receiving the key parameter and the identifier of the target terminal device from the first terminal device, the first RAN device finds the target terminal device based on the identifier of the target terminal device, and sends the key parameter to the target terminal device, so that when subsequently receiving encrypted data from the first terminal device, the target terminal device can generate a corresponding session group key based on the key parameter, to decrypt the encrypted transmission data, or when subsequently sending data to the first terminal device, the target terminal device encrypts the transmission data based on the key parameter, to ensure data security during communication with the first terminal device.

During specific implementation, in addition to the first terminal device, another terminal device may provide a key parameter for the target terminal device. Therefore, to enable the target terminal device to differentiate between these key parameters, when sending the key parameter of the first terminal device (where for ease of description, in this specification, the key parameter provided by the first terminal device is referred to as a first key parameter) to the target terminal device, the first RAN may further send the identifier of the first terminal device to the target terminal device, so that the target terminal device can identify that the first key parameter corresponds to the first terminal device.

In a possible implementation, after receiving the first key parameter, the terminal device may further store the first key parameter. In this way, when the target terminal device subsequently communicates with the first terminal device, the first terminal device may not need to repeatedly provide the first key parameter, thereby reducing system overheads.

As described above, in the communication system, each terminal device may serve as a communication initiator, or may serve as a communication receiver. Therefore, a non-access stratum of each terminal device may need to maintain a plurality of sets of key parameters. One set of key parameters is a key parameter used when the terminal device serves as the communication initiator, and another set of key parameters is a key parameter used when the terminal device serves as the communication receiver (that is, a terminal device of another communication initiator). For example, it is assumed that the UE 1 serves as a communication initiator to communicate with the UE 2, and also serves as a communication receiver to communicate with the UE 3 and the UE 4. In this case, the UE 1 needs to maintain not only the count 1 of the UE 1 that serves as the communication initiator but also the count 3 of the UE 3 that serves as a communication initiator and the count 4 of the UE 4 that serves as a communication initiator. Therefore, the target terminal may jointly store the first key parameter and the identifier of the first terminal device, to differentiate between key parameters provided by specific terminal devices.

In a specific example, the target terminal device may locally maintain a mapping table, where the mapping table stores a correspondence between each terminal device and a key parameter provided by each terminal device.

For example, as shown in Table 1, the key parameter provided by the UE 1 is the count 1, the key parameter provided by the UE 2 is the count 2, and the key parameter provided by the UE 3 is the count 3.

TABLE 1

| Identifier of a terminal device | Key parameter |
|---|---|
| UE 1 | Count 1 |
| UE 2 | Count 2 |
| UE 3 | Count 3 |
| . . . | . . . |

In this embodiment of this application, the target terminal device may be a single device, or may be a plurality of terminal devices. This is not specifically limited in this embodiment of this application.

In a first case, the target terminal device is a single terminal device, for example, a second terminal device.

The identifier of the target terminal may be a first identifier of the second terminal device, and the first identifier includes a device identifier, for example, an IP address, a MAC address, or an identifier of the first terminal device in the terminal device group to which the first terminal device belongs.

Before the first RAN device sends the first key parameter and the identifier of the first terminal device to the target terminal device, the first RAN device needs to determine a second identifier of the second terminal device based on the first identifier of the second terminal device. The second identifier herein includes a cell radio network temporary identifier (C-RNTI). Optionally, when accessing a base station, each terminal device may send a first identifier of the terminal device to the base station. Subsequently, after the base station allocates a second identifier to the terminal device, the base station and the terminal device separately store a mapping relationship between the first identifier and the second identifier of the terminal device. In this way, when determining the second identifier of the second terminal device based on the first identifier of the second terminal device, the first RAN device can quickly determine the second identifier of the second terminal device based on the mapping relationship.

After the first RAN device determines the second identifier of the second terminal device based on the first identifier of the second terminal device, the first RAN device sends the first key parameter and the identifier of the first terminal device to the second terminal device based on the C-RNTI of the second terminal device. The identifier of the first terminal device herein may be a first identifier of the first terminal device.

In a second case, the target terminal device is a plurality of terminal devices.

Correspondingly, the identifier of the target terminal may include a first identifier of each of the plurality of terminal devices. The first RAN device converts the first identifier of each of the plurality of terminal devices into a second identifier, and then sends the first key parameter and the identifier of the first terminal device to each of the plurality of terminal devices.

In a specific example, the plurality of terminal devices may alternatively be one terminal device group, and the identifier of the target terminal may be a group identifier of the terminal device group. The first RAN device may send the first key parameter and the identifier of the first terminal device to the terminal device group through a multicast channel. The multicast channel corresponds to the terminal device group.

In this embodiment of this application, the target terminal device and the first terminal device may be located in a coverage area of a same RAN device (namely, the first RAN device) (that is, a co-site case), or the target terminal device and the first terminal device may be located in coverage areas of different RAN devices (that is, a cross-site case).

In a first case, when the target terminal device and the first terminal device are co-sited, the first RAN device may directly send the first key parameter and the identifier of the first terminal device to the target terminal device.

In a second case, when the target terminal device and the first terminal device are cross-sited, the first RAN device needs to send the first key parameter and the identifier of the first terminal device to the target terminal device by using another RAN device.

In a possible example, the first RAN device may send the identifier of the target terminal device to a surrounding RAN device (namely, a RAN device in a neighboring cell), and query a coverage area of a RAN device in which the target terminal device is located. It is assumed that the target terminal device is located in a coverage area of a second RAN device, the second RAN device responds to the query of the first RAN device. After the first RAN device learns that the target terminal device is located in the coverage area of the second RAN device, the first RAN device sends the first key parameter, the identifier of the first terminal device, and the identifier of the target terminal device to the second RAN device, and then the second RAN device sends the first key parameter and the identifier of the first terminal device to the target terminal device. In this case, the coverage area of the first RAN device at least partially overlaps with the coverage area of the second RAN device.

In another possible example, the first RAN device and the second RAN device may periodically exchange a first identifier of a terminal device served by the first RAN device and a first identifier of a terminal device served by the second RAN device with each other. In this case, when receiving the first identifier of the terminal device, the first RAN device may determine, based on previously exchanged content between the devices, the second RAN device corresponding to the first identifier. Certainly, the foregoing is merely an example and does not constitute a limitation. During specific implementation, the first RAN device may further send the first key parameter to the target terminal device by using more RAN devices.

In this embodiment of this application, a terminal device communicates with a RAN device by using a first protocol stack, and an end-to-end second protocol stack exists between terminal devices.

Specifically, the first terminal device communicates with the first RAN device by using the first protocol stack, and the end-to-end second protocol stack exists between the first terminal device and the target terminal device. If the first terminal device and the target terminal device are co-sited, the target terminal device further communicates with the first RAN device by using the first protocol stack. If the first terminal device and the target terminal device are cross-sited, for example, the target terminal device is located in the coverage area of the second RAN device, the target terminal device further communicates with the second RAN device by using the first protocol stack. The first protocol stack includes at least a PHY layer, and may further include a MAC layer, an RLC layer, an adaptation layer, or the like. The second protocol stack includes at least a PDCP layer, and may further include a service data adaptation protocol (SDAP) layer, an RLC layer, a MAC layer, or the like. In a possible case, the first protocol stack includes the PHY layer, the MAC layer, the RLC layer, and the adaptation layer, and the second protocol stack includes the PDCP layer.

In this embodiment of this application, a process in which the first terminal device transmits the first key parameter to the target terminal device by using the RAN device may be implemented by using a control plane (CP) transmission solution, or may be implemented by using a user plane (UP) transmission solution. This is not limited herein.

Solution 1: CP Transmission Solution

For example, the first terminal device first sends the first key parameter and the identifier of the target terminal device to the first RAN device by using an uplink RRC message. Certainly, the uplink RRC message is merely an example and does not constitute a limitation. During specific implementation, the first key parameter and the identifier of the target terminal device may alternatively be sent to a base station in another control plane transmission mode. For example, the first key parameter and the identifier of the target terminal device are carried in a MAC control element (CE), a PHY header, a MAC header, or an RLC header.

If the target terminal device and the first terminal device are co-sited, the first RAN device sends the first key parameter and the identifier of the first terminal device to the target terminal device by using a downlink RRC message.

If the target terminal device and the first terminal device are cross-sited, for example, the target terminal device is in the coverage area of the second RAN device, the first RAN device may first send the key parameter, the identifier of the first terminal device, and the identifier of the target terminal device to the second RAN device by using an interface message (for example, an XnAP message) between the first RAN device and the second RAN device. Then, the second RAN device sends the key parameter and the identifier of the first terminal device to the target terminal device by using a downlink RRC message.

Solution 2: UP Transmission Solution

For example, the first terminal device may send first data to the first RAN device. A first encapsulation header encapsulated outside the first data includes the key parameter and the identifier of the target terminal device. That is, the first data includes payload data and the first encapsulation header.

The first RAN receives the first data, and parses the first data to obtain the key parameter and the identifier of the target terminal device. If the target terminal device and the first terminal device are co-sited, the first RAN device sends second data to the target terminal device. The second data includes payload data and a second encapsulation header. It should be understood that herein, the first data and the second data include same payload data. A difference lies in that encapsulation headers outside the first data and the second data are different. The first encapsulation header outside the first data includes the key parameter and the identifier of the target terminal device, while the second encapsulation header outside the second data includes the key parameter and the identifier of the first terminal device.

If the target terminal device and the first terminal device are cross-sited, for example, the target terminal device is in the coverage area of the second RAN device, the first RAN device sends a data packet encapsulated by a general packet radio service tunneling protocol-user plane (GTP-U) to the second RAN device. The first key parameter, the identifier of the first terminal device, and the identifier of the target terminal device are encapsulated in a packet header of the data packet encapsulated by the GTP-U, and the data packet encapsulated by the GTP-U includes the payload data. Then, the second RAN device sends third data to the target terminal device. The third data includes the payload data and a third encapsulation header. The third encapsulation header outside the third data includes the first key parameter and the identifier of the first terminal device. It should be understood that herein, the first data and the third data include same payload data.

During specific implementation, both the control plane transmission solution and the user plane transmission solution may be implemented in different transmission phases.

For example, it is assumed that UE 1 expects to communicate with target UE, and the UE 1 and the target UE are covered by a same base station, the UE 1 may first send a first identifier of the target UE and a key parameter to the base station by using an uplink RRC message. Then the base station determines a second identifier (for example, a C-RNTI) of the target UE based on the first identifier of the target UE, and sends a downlink RRC message (which may also be another MAC CE, a PHY header, a MAC header, an RLC header, or the like) based on the second identifier, to notify the target UE of a first identifier of the first UE and the key parameter. Then the first UE may send a data packet to the target UE. When the UE 1 sends the data packet to the target UE by using the base station, the UE 1 may include the key parameter in each data packet, or may send one or more data packets to carry an updated key parameter after the key parameter is updated. This is not limited in this embodiment of this application.

When the UE 1 sends the data packet to the base station, the data packet may include the first identifier of the target UE, may further include a network slice identifier (ID) and/or a QFI of the target UE, and may further include the first identifier of the first UE.

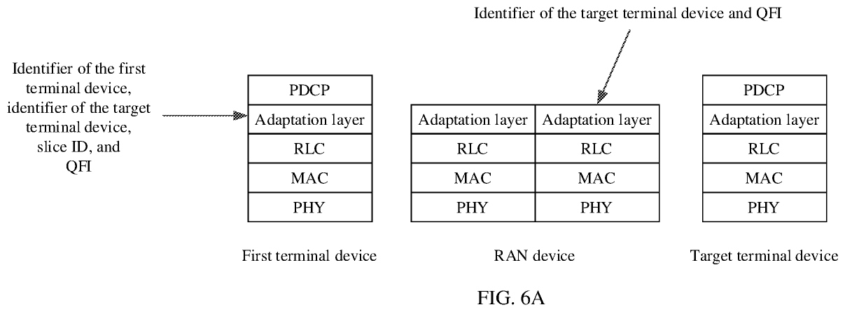

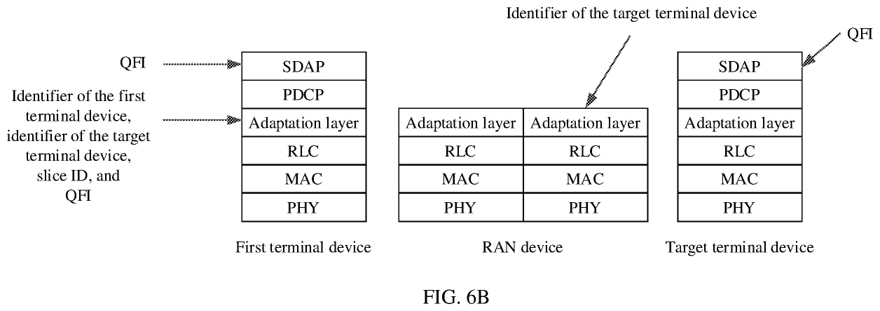

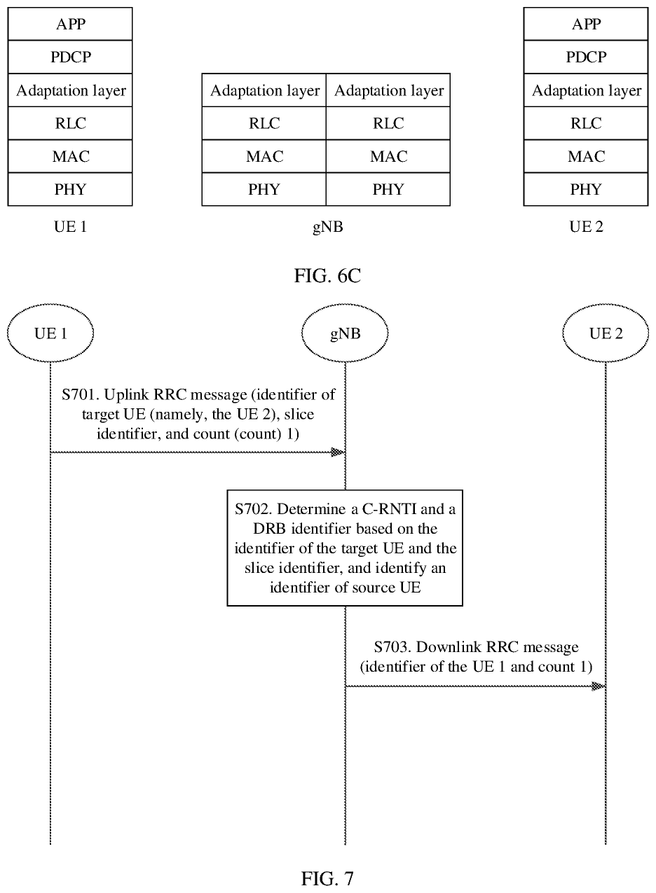

FIG. 6A is a schematic diagram of a possible user plane protocol stack. Protocol layers of a data packet sequentially include a PDCP layer, an adaptation layer, an RLC layer, a MAC layer, and a PHY layer from top to bottom. The adaptation layer may be used by a transmit end to notify a receive end of a node from which the data packet comes (where for example, the adaptation layer carries an identifier of source UE) and a node to which the data packet needs to be sent (where for example, the adaptation layer carries an identifier of target UE). Optionally, the adaptation layer may further carry a network slice identifier (slice ID), a quality of service flow identifier (QFI), or the like of a target node.

FIG. 6B is a schematic diagram of another possible user plane protocol stack. Protocol layers of a data packet sequentially include an SDAP layer, a PDCP layer, an adaptation layer, an RLC layer, a MAC layer, and a PHY layer from top to bottom. A main difference between FIG. 6A and FIG. 6B lies in whether an adaptation layer of a data packet processed by a RAN device needs to carry a QFI. If no SDAP layer exists, the QFI may be carried, as shown in FIG. 6A. However, when the SDAP layer exists, because the SDAP layer includes the QFI, the QFI does not need to be carried at the adaptation layer, as shown in FIG. 6B.

It should be understood that content included in an adaptation layer of a first terminal device, an adaptation layer of a RAN device, and an adaptation layer of a target terminal device may be different. For example, when the first terminal device sends a data packet to the RAN device, a first identifier of the target terminal device, a slice ID, a QFI, and the like are all included in an adaptation layer of the data packet. The RAN device determines a C-RNTI based on the first identifier of the target terminal device, and then determines a DRB based on the slice ID and/or the QFI. It is assumed that before the RAN device determines the C-RNTI based on the first identifier of the target terminal device, and then determines the DRB based on the slice ID and/or the QFI, the RAN device may send an RRC reconfiguration message to the target terminal device. The RRC reconfiguration message includes a mapping relationship between a slice ID and a DRB, a mapping relationship between a QFI and a DRB, or a mapping relationship among a slice ID, a QFI, and a DRB. In this case, the RAN device may determine the C-RNTI or the DRB based on the mapping relationship. When switching the data packet, the RAN device may delete the identifier of the target terminal device from the adaptation layer of the data packet, and reserve a first identifier of the first terminal device (where if the data packet sent by the first terminal device does not include the first identifier of the first terminal device, the RAN device may find, based on the C-RNTI of the first terminal device during switching, the first identifier corresponding to the first terminal device, and include the first identifier of the first terminal device in the adaptation layer), or may delete the slice ID from the adaptation layer, and reserve the QFI. The slice ID is deleted because the RAN device notifies, in the RRC configuration message, the target terminal device that specific QFIs of a specific slice correspond to a specific DRB. Therefore, the target terminal device may determine a specific slice from which the data packet comes. The QFI is reserved because a base station initially configures a reflective QoS mechanism for the target terminal device. To be specific, the target terminal device needs to determine, based on a QFI included in a downlink data packet, that a specific QFI corresponds to a specific DRB. The target terminal device may subsequently determine the mapping relationship based on the QFI included in the downlink data packet and the DRB corresponding to the downlink data, and determine, based on a QFI corresponding to an uplink data packet by using the mapping relationship, a specific DRB to which the uplink data packet belongs.

FIG. 6C is a schematic diagram of another possible user plane protocol stack. As shown in FIG. 6C, an application (APP) layer is further included above a PDCP layer, and the APP layer is used to generate payload data that UE 1 expects to send to UE 2. A protocol layer between the UE 1 and a gNB is an adaptation layer, an RLC layer, a MAC layer, and a PHY layer, and a protocol layer between the UE 2 and the gNB is an adaptation layer, an RLC layer, a MAC layer, and a PHY layer. When sending a data packet to the gNB, the UE 1 sequentially encapsulates an adaptation header, an RLC header, a MAC header, and a PHY header outside the data packet.

In a possible design, a first terminal device may obtain a first key parameter in a process of requesting a PDU session from a core network.

For example, the UE 1 may request a PDU session from a core network, and the PDU session is subsequently used in communication that is performed through RAN local switch. The UE 1 initiates a request for establishing a PDU session to the core network, where the request may include one or more of a UE group identifier, a slice identifier, a RAN local switch identifier, and the like. After receiving the request, the core network identifies, based on the RAN local switch identifier, a specific UE group or a specific slice to which the UE 1 belongs, performs exclusive OR calculation on K_{AMF} or K_{gNB} of another UE that is in the UE group or that requests the slice service, to obtain Derpara, and sends Derpara, a count 1, a security algorithm, and the like to the UE 1. It should be understood that the count 1 herein may be specially configured by the core network for the UE 1, and a count value configured by the core network for another UE may be different from the count 1. The UE 2 requests a request for establishing a PDU session to the core network, and the core network performs similar operations.

After the UE 1 receives a key parameter (for example, Derpara, the count 1, and the security algorithm) provided by the core network, a non-access stratum of the UE 1 sends K_{AMF}1 or K_{gNB}1, Derpara, the count 1, and the like of the UE 1 to an AS of the UE 1, sends a count value and a parameter that is obtained by performing exclusive OR calculation on K_{AMF}1 or K_{gNB}1 and Derpara to an AS, or may directly generate a session group key based on the method shown in FIG. 3 and then send the generated session group key to an AS. In addition, the NAS of the UE 1 may further provide a corresponding PDU session identifier for the AS, so that the UE 1 learns of a specific PDU session that needs to use a key or the key parameter provided by the NAS. When the UE 1 subsequently receives an RRC reconfiguration message from a base station, the UE 1 can learn, based on the RRC reconfiguration message, of a PDU session identifier corresponding to a DRB, where the RRC reconfiguration message may include the DRB and SDAP-Config corresponding to the DRB, and the SDAP-Config may include the PDU session identifier. When subsequently transmitting a PDU session, the UE 1 compares a PDU session identifier of the current session with the PDU session identifier previously provided by the NAS. If the PDU session identifiers are the same, an end-to-end key or key parameter provided by the NAS is used. Otherwise, a conventional encryption mechanism is performed (for example, encryption/decryption is performed by using a key parameter agreed on by the UE 1 and the base station). In addition, the UE 1 may determine, based on a mapping relationship between a PDU session identifier and a DRB, DRBs that use the end-to-end key or key parameter provided by the NAS, and DRBs that use the conventional encryption mechanism.

The foregoing implementations may be combined with each other to achieve different technical effects.

To better understand the technical solutions in embodiments of this application, the following lists two specific embodiments to describe the technical solutions of this application in more detail.

### Embodiment 1

This embodiment describes a process in which UE 1 provides a count 1 for UE 2 when the UE 1 and the UE 2 are co-sited.

Solution 1: Refer to FIG. 7. The UE 1 Transmits the Count 1 to the UE 2 Through a CP Plane.

S701. The UE 1 notifies, by using an uplink RRC message, a gNB of target UE (for example, the UE 2) with which the UE 1 expects to communicate. A specific manner may be sending an identifier (a target ID) of the target UE and a key parameter, namely, the count 1 of the UE 1 to the gNB. Optionally, the uplink RRC message may further carry a slice ID, a QoS flow identifier QFI, and the like, so that the gNB does not need to additionally initiate a procedure to obtain information such as the slice ID and the QoS flow identifier QFI. This can help the gNB more quickly determine a specific bearer to which data subsequently transmitted through a user plane is switched and that is of the UE 2, thereby improving data transmission efficiency.

The target ID may be an IP address, a MAC address, or the like of the UE 2. In this specification, the target ID is referred to as a first identifier used for RAN local switch. If the UE 1 expects to communicate with a UE group, the target ID may alternatively be a UE group identifier.

S702. The gNB determines, based on the identifier of the target UE and the slice identifier, a C-RNTI and a DRB identifier that correspond to the target UE. Optionally, the gNB may further need to identify an identifier of source UE.

In this embodiment of this application, all UEs may first report first identifiers to the gNB when accessing the gNB, and then the gNB may allocate a second identifier, for example, a C-RNTI, to each UE. Therefore, the gNB can obtain and store a mapping relationship between the first identifier and the second identifier of each UE. When receiving the message sent by the UE 1, the gNB may determine a first identifier of the UE 1 based on a C-RNTI of the UE 1. When the UE 1 notifies the gNB that the UE 1 expects to communicate with the UE 2 (a first identifier of the UE 2), the gNB may find a second identifier corresponding to the UE 2, and then send a data packet to the UE 2 corresponding to the second identifier through an air interface.

When the UE 1 communicates with a UE group, when accessing the gNB, the UE not only sends the first identifier to the gNB, but also may send, to the gNB, an identifier of a UE group to which the UE belongs, or an operation, administration, and maintenance (OAM) sends a UE group identifier and a first identifier of each member in the UE group to the gNB, or an AMF in a core network sends a UE group identifier and a first identifier of each member in the UE group to the gNB. In this way, when the UE 1 notifies the gNB that the UE 1 expects to communicate with a UE group, the gNB may send data of the UE 1 to all members in the UE group in a unicast or multicast mode.

After determining that the target UE that the UE 1 needs to communicate with is the UE 2, the gNB further needs to determine a specific data radio bearer DRB that is used to send the data packet from the UE 1 and that is of the UE 2. Specifically, the gNB may determine the specific DRB of the UE 2 based on information such as the UE group identifier, the slice identifier, or the QFI. Optionally, when the UE 2 establishes the DRB, an RRC reconfiguration message of the gNB may indicate a mapping relationship between the DRB and a UE group identifier, a mapping relationship between a DRB and a slice, or a mapping relationship between a DRB and a QFI list. In this way, the gNB can directly determine the DRB of the UE 2 based on the mapping relationship.

S703. The gNB notifies the UE 2 of the count 1 and the first identifier of the UE 1 by using a downlink RRC reconfiguration message, downlink control information (DCI), or another protocol layer message.

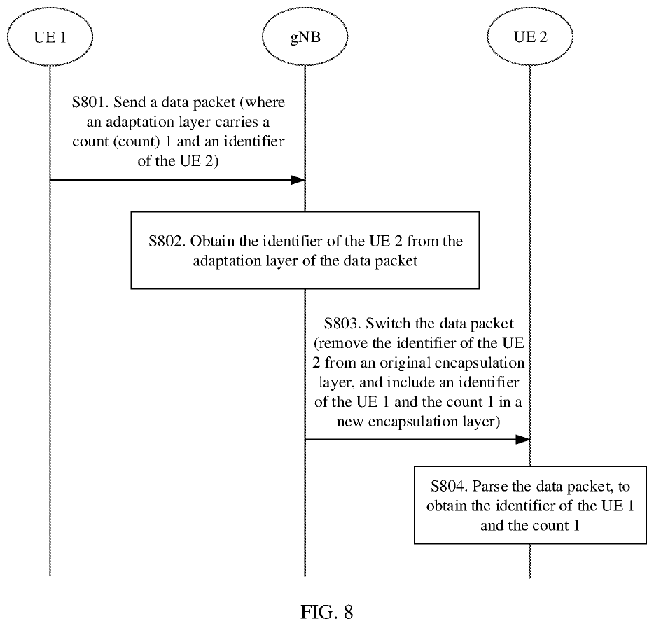

Solution 2: Refer to FIG. 8. The UE 1 transmits the count 1 to the UE 2 through a UP plane.

S801. The UE 1 sends a data packet to a gNB. The data packet carries the count 1, an identifier of target UE (for example, an identifier of UE 2) with which the UE 1 expects to communicate, and the like.

When sending the data packet to the gNB, the UE 1 may sequentially encapsulate an adaptation header, an RLC header, a MAC header, and a PHY header outside the data packet based on the protocol stack shown in FIG. 6C. Optionally, the adaptation layer may include a first identifier of the UE 2 and a value of a key parameter, namely, the count 1, and may further include other parameters such as a slice identifier and a QFI.

S802. After receiving the data packet sent by the UE 1, the gNB obtains the first identifier of the UE 2 from the adaptation layer of the data packet. Optionally, if the adaptation layer further includes the other parameters such as the slice identifier and the QFI, a C-RNTI of the UE 2 and a corresponding DRB may be determined based on the slice identifier and the QFI.

S803. When switching the data packet from the UE 1 to the UE 2, the gNB removes the identifier of the UE 2 from the original adaptation layer (where optionally, if the original adaptation layer further includes the slice identifier, the QFI, and the like, the slice identifier, the QFI, and the like may be further removed), sequentially encapsulates a new adaptation/RLC/MAC/PHY layer outside the data packet, and includes a first identifier of the UE 1 and the key parameter, namely, the count 1 in the new adaptation layer.

S804. When receiving the data packet switched by the gNB, the UE 2 obtains the first identifier of the UE 1 and the count 1 from the adaptation layer.

In this embodiment, the UE 1 may include the count 1 in each data packet sent to the UE 2, or send the count value for one or more times when the count 1 changes, or stop including the count 1 in the data packet when receiving feedback, from the UE 2, indicating that the UE 2 has received the count 1.

### Embodiment 2

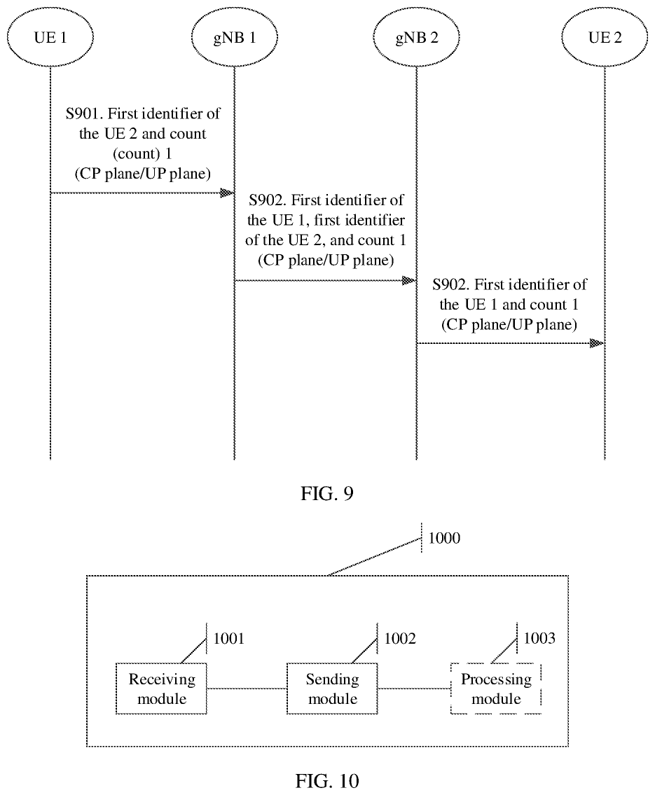

This embodiment describes a process in which UE 1 provides a count 1 for UE 2 when the UE 1 and the UE 2 are cross-sited. It is assumed that the UE 1 is in a coverage area of a gNB 1, the UE 2 is in a coverage area of a gNB 2, and the UE 1 expects to communicate with the UE 2. As shown in FIG. 9, the method includes the following steps.

S901. The UE 1 sends a first identifier of the UE 2, a count 1, and the like to the gNB 1 through a CP plane or a UP plane. For a specific implementation, refer to the specific implementation of S701 or S801 in Embodiment 1. Details are not described herein again.

S902. The gNB 1 sends a first identifier of the UE 1, the first identifier of the UE 2, and the count 1 to the gNB 2 through the CP plane or the UP plane.

First, the gNB 1 finds, based on the first identifier of the UE 2, that the UE 2 is not in the coverage area of the gNB 1 but is in the coverage area of the gNB 2. In a possible case, the gNB 1 sends the first identifier of the UE 2 to a surrounding neighboring cell for a query, and finally determines that the UE 2 is in the coverage area of the gNB 2. In another possible case, gNBs periodically exchange first identifiers of UEs in coverage areas of the gNBs, and finally determine that the UE 2 is in the coverage area of the gNB 2. In still another possible case, a gNB reports a first identifier of UE in a coverage area of the gNB to a core network. When the gNB expects to obtain a gNB in which the UE is located, the gNB initiates a query to the core network.

Then, the gNB 1 encapsulates a GTP-U header outside a data packet from the UE 1, and finally sends the entire data packet encapsulated by the GTP-U to the gNB 2 through a GTP-U tunnel between the gNB 1 and the gNB 2. The first identifier of the UE 1, the first identifier of the UE 2, the count 1, and the like may all be encapsulated in the header of the data packet encapsulated by the GTP-U. Certainly, the gNB 1 may alternatively notify the gNB 2 of the first identifier of the UE 1, the first identifier of the UE 2, the count 1, and the like by using a CP plane message, for example, an XnAP message, between the gNB 1 and the gNB 2. For example, the gNB 1 sends the XnAP message such as a direct communication request message to the gNB 2, where the XnAP message includes the first identifier of the UE 1, the first identifier of the UE 2, the count 1, and the like.

It should be understood that information sent by the gNB 1 to the gNB 2 may further include a slice ID, a UE group identifier, a QFI, and the like that are provided by the UE 1. This is not limited herein.

S903. After receiving the foregoing information by using the CP plane message or a UP plane message, the gNB 2 transmits the first identifier of the UE 1, the count 1, and the like to the UE 2 through the CP plane or the UP plane. For a specific implementation, refer to the specific implementation of S703 or S803 in Embodiment 1. Details are not described herein again.

The foregoing describes the key management method provided in embodiments of this application. The following describes, with reference to the accompanying drawings, a communication apparatus configured to implement the foregoing method in embodiments of this application. Therefore, all the foregoing content may be used in the following embodiments. Repeated content is not described in detail again.

Based on a same technical concept, as shown in FIG. 10, an embodiment of this application provides a communication apparatus 1000. The apparatus 1000 may be the first RAN device in the foregoing method embodiments, or an apparatus in the first RAN device. The apparatus 1000 includes a receiving module 1001, configured to receive a key parameter and an identifier of a target terminal device that are sent by a first terminal device, where the key parameter is used to encrypt and/or decrypt transmission data when the first terminal device and the target terminal device communicate with each other, and a sending module 1002, configured to send the key parameter and an identifier of the first terminal device to the target terminal device.

In a possible implementation, the target terminal device is located in a coverage area of the first RAN device.

In a possible implementation, the target terminal device is located in a coverage area of a second RAN device, and the sending module 1002 is specifically configured to send the key parameter and the identifier of the first terminal device to the target terminal device by using the second RAN device.

In a possible implementation, the first terminal device communicates with the first RAN device by using a first protocol stack, the target terminal device communicates with the first RAN device by using the first protocol stack, and an end-to-end second protocol stack exists between the first terminal device and the target terminal device. The first protocol stack includes a physical PHY layer, a media access control MAC layer, and a radio link control RLC layer, and the second protocol stack includes a packet data convergence protocol PDCP layer, a service data adaptation protocol SDAP layer, an RLC layer, and a MAC layer.

In a possible implementation, the key parameter is a parameter required for the first terminal device and the target terminal device to separately generate a session key.

In a possible implementation, the receiving module 1001 is specifically used by the first RAN device to receive first data sent by the first terminal device. An encapsulation header encapsulated outside the first data includes the key parameter and the identifier of the target terminal device.

In a possible implementation, the sending module 1002 is specifically configured to send second data to the target terminal device. An encapsulation header outside the second data includes the key parameter and the identifier of the first terminal device.

In a possible implementation, the sending module 1002 is specifically configured to send a data packet encapsulated by a general packet radio service tunneling protocol-user plane GTP-U to a second RAN device, where a packet header of the data packet encapsulated by the GTP-U carries the key parameter, the identifier of the first terminal device, and the identifier of the target terminal device, and the data packet encapsulated by the GTP-U includes the first data, and send the key parameter and the identifier of the first terminal device to the target terminal device by using the second RAN device.

In a possible implementation, the identifier of the target terminal device includes a first identifier of a second terminal device.

The apparatus 1000 further includes a processing module 1003, configured to determine a second identifier of the second terminal device based on the first identifier of the second terminal device before the sending module 1002 sends the key parameter and an identifier of the first terminal device to the target terminal device, where the first identifier includes a device identifier, and the second identifier includes a cell radio network temporary identifier C-RNTI, and the sending module 1002 is specifically configured to send the key parameter and the identifier of the first terminal device to the second terminal device based on the second identifier of the second terminal device.

In a possible implementation, the identifier of the target terminal device includes a group identifier of a terminal device group to which the first terminal device belongs.

The sending module 1002 is specifically used by the first RAN device to send the key parameter and the identifier of the first terminal device to the terminal device group through a multicast channel. The multicast channel corresponds to the terminal device group.

Based on a same technical concept, as shown in FIG. 11, an embodiment of this application provides a communication apparatus 1100. The apparatus 1100 may be the first terminal device in the foregoing method embodiments, or an apparatus in the first terminal device. The apparatus 1100 includes a processing module 1101, configured to determine a key parameter and an identifier of a target terminal device, where the key parameter is used to encrypt and/or decrypt transmission data when the first terminal device and the target terminal device communicate with each other, and a sending module 1102, configured to send the key parameter and the identifier of the target terminal device to a first radio access network RAN device.

In a possible implementation, the target terminal device is located in a coverage area of the first RAN device.

In a possible implementation, the target terminal device is located in a coverage area of a second RAN device.

In a possible implementation, the first terminal device communicates with the first RAN device by using a first protocol stack, the target terminal device communicates with the first RAN device by using the first protocol stack, and an end-to-end second protocol stack exists between the first terminal device and the target terminal device. The first protocol stack includes a physical PHY layer, a media access control MAC layer, and a radio link control RLC layer, and the second protocol stack includes a packet data convergence protocol PDCP layer, a service data adaptation protocol SDAP layer, an RLC layer, and a MAC layer.

In a possible implementation, the key parameter is a parameter required for the first terminal device and the target terminal device to separately generate a session key.

In a possible implementation, the sending module 1102 is specifically configured to send first data to the first radio access network RAN device. An encapsulation header encapsulated outside the first data includes the key parameter and the identifier of the target terminal device.

In a possible implementation, the identifier of the target terminal device includes a first identifier of a second terminal device, and the first identifier includes a device identifier.

In a possible implementation, the identifier of the target terminal device includes a group identifier of a terminal device group to which the first terminal device belongs.

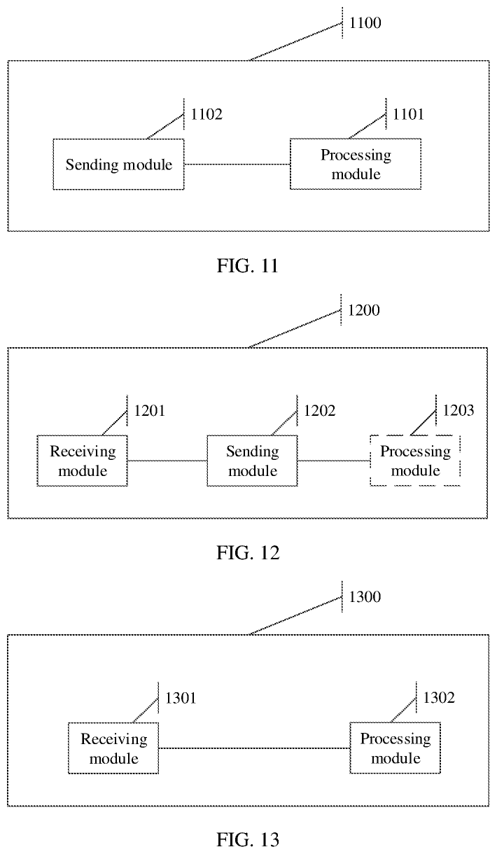

Based on a same technical concept, as shown in FIG. 12, an embodiment of this application provides a communication apparatus 1200. The apparatus 1200 may be the second RAN device in the foregoing method embodiments, or an apparatus in the second RAN device. The apparatus 1200 includes a receiving module 1201, configured to receive a key parameter, an identifier of a first terminal device, and an identifier of a target terminal device that are sent by a first RAN device, where the key parameter is used to encrypt and/or decrypt transmission data when the first terminal device and the target terminal device communicate with each other, and a sending module 1202, configured to send the key parameter and an identifier of the first terminal device to the target terminal device.

In a possible implementation, the target terminal device communicates with the second RAN device by using a first protocol stack, and an end-to-end second protocol stack exists between the first terminal device and the target terminal device. The first protocol stack includes a physical PHY layer, a media access control MAC layer, and a radio link control RLC layer, and the second protocol stack includes a packet data convergence protocol PDCP layer, a service data adaptation protocol SDAP layer, an RLC layer, and a MAC layer.

In a possible implementation, the key parameter is a parameter required for the first terminal device and the target terminal device to separately generate a session key.

In a possible implementation, the receiving module 1201 is specifically configured to receive a data packet encapsulated by a general packet radio service tunneling protocol-user plane GTP-U sent by the first RAN device. A packet header of the data packet encapsulated by the GTP-U carries the key parameter, the identifier of the first terminal device, and the identifier of the target terminal device.

In a possible implementation, the sending module 1202 is specifically configured to send third data to the target terminal device. An encapsulation header outside the third data includes the key parameter and the identifier of the first terminal device.

In a possible implementation, the identifier of the target terminal device includes a first identifier of a second terminal device.

The apparatus 1200 further includes a processing module 1203, configured to determine a second identifier of the second terminal device based on the first identifier of the second terminal device before the sending module 1202 sends the key parameter and an identifier of the first terminal device to the target terminal device, where the first identifier includes a device identifier, and the second identifier includes a cell radio network temporary identifier C-RNTI.

The sending module 1202 is specifically configured to send the key parameter and the identifier of the first terminal device to the second terminal device based on the second identifier of the second terminal device.

In a possible implementation, the identifier of the target terminal device includes a group identifier of a terminal device group to which the first terminal device belongs, and the sending module 1202 is specifically configured to send the key parameter and the identifier of the first terminal device to the terminal device group through a multicast channel. The multicast channel corresponds to the terminal device group.

Based on a same technical concept, as shown in FIG. 13, an embodiment of this application provides a communication apparatus 1300. The apparatus 1300 may be the target terminal device in the foregoing method embodiments, or an apparatus in the target terminal device. The apparatus 1300 includes a receiving module 1301, configured to receive a key parameter and an identifier of a first terminal device that are sent by a first RAN device or a second RAN device, and a processing module 1302, configured to encrypt and/or decrypt transmission data by using the key parameter when the target terminal device and the first terminal device communicate with each other.

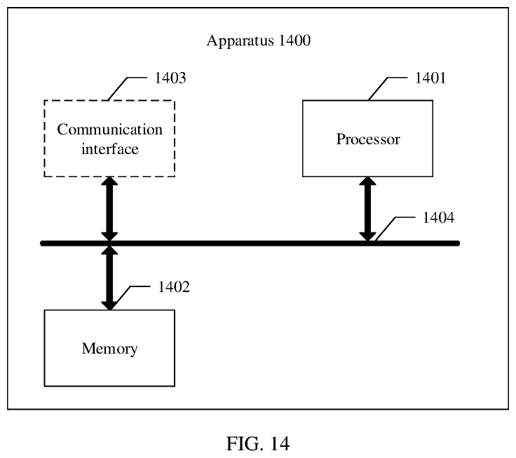

Based on a same technical concept, as shown in FIG. 14, an embodiment of this application provides a communication apparatus 1400, including at least one processor 1401, and a memory 1402 communicatively connected to the at least one processor 1401, where the memory 1402 stores instructions that can be executed by the at least one processor 1401, and the at least one processor 1401 executes the instructions stored in the memory 1402, to perform the method in the embodiment shown in FIG. 5, FIG. 7, FIG. 8, or FIG. 9.

The processor 1401 may be a general-purpose processor, a digital signal processor, an application-specific integrated circuit, a field programmable gate array or another programmable logic device, a discrete gate or a transistor logic device, or a discrete hardware component, and may implement or execute the methods, steps, and logical block diagrams disclosed in embodiments of this application. The general-purpose processor may be a microprocessor, any conventional processor, or the like. The steps of the methods disclosed with reference to embodiments of this application may be directly performed by a hardware processor, or may be performed by a combination of hardware in the processor and a software module.

The memory 1402 may be a non-volatile memory, for example, a hard disk drive (hard disk drive, HDD), or a solid-state drive (SSD), or may be a volatile, for example, a random access memory (RAM). The memory is any other medium that can be used to carry or store expected program code in a form of an instruction structure or a data structure and that can be accessed by a computer, but is not limited thereto. The memory in this embodiment of this application may alternatively be a circuit or any other apparatus that can implement a storage function, and is configured to store program instructions and/or data.

Optionally, the apparatus 1400 may further include a communication interface 1403. The communication interface 1403 is used by the apparatus 1400 to communicate with another module. The other module may be a circuit, a device, an interface, a bus, a software module, a transceiver, or any other apparatus that can implement communication.

It should be noted that, in this embodiment of this application, a specific connection medium between the communication interface 1403, the processor 1401, and the memory 1402 is not limited. In this embodiment of this application, in FIG. 14, the communication interface 1403, the processor 1401, and the memory 1402 are connected through a bus 1404. The bus is represented by a bold line in FIG. 14. A connection manner between other components is merely an example for description, and is not limited thereto. The bus may be classified into an address bus, a data bus, a control bus, or the like. For ease of representation, the bus is represented by using only one bold line in FIG. 14. However, it does not indicate that there is only one bus or only one type of bus.

Based on a same technical concept, an embodiment of this application further provides a computer-readable storage medium. The computer-readable storage medium stores a computer program. The computer program includes program instructions. When the program instructions are executed by a computer, the computer is enabled to perform the method in the embodiment shown in FIG. 5, FIG. 7, FIG. 8, or FIG. 9.

Based on a same technical concept, an embodiment of this application further provides a chip. The chip is coupled to a memory, and is configured to read and execute program instructions stored in the memory, to implement the method in the embodiment shown in FIG. 5, FIG. 7, FIG. 8, or FIG. 9.

All related content of the steps in the foregoing method embodiments may be cited in function descriptions of corresponding function modules. Details are not described herein again.

A person skilled in the art should understand that embodiments of this application may be provided as a method, a system, or a computer program product. Therefore, this application may use a form of hardware only embodiments, software only embodiments, or embodiments with a combination of software and hardware. In addition, this application may use a form of a computer program product that is implemented on one or more computer-usable storage media (including but not limited to a disk memory, a CD-ROM, an optical memory, and the like) that include computer usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, so that instructions executed by the computer or the processor of the other programmable data processing device generate an apparatus for implementing a specific function in one or more processes in the flowcharts and/or in one or more blocks in the block diagrams.

These computer program instructions may be stored in a computer-readable memory that can indicate a computer or another programmable data processing device to work in a specific manner, so that instructions stored in the computer-readable memory generate an artifact that includes an instruction apparatus. The instruction apparatus implements a specific function in one or more processes in the flowcharts and/or in one or more blocks in the block diagrams.

These computer program instructions may alternatively be loaded onto a computer or another programmable data processing device, so that a series of operations and steps are performed on the computer or another programmable device, thereby generating computer-implemented processing. Therefore, the instructions executed on the computer or another programmable device provide steps for implementing a specific function in one or more processes in the flowcharts and/or in one or more blocks in the block diagrams.

Clearly, a person skilled in the art can make various modifications and variations to this application without departing from the protection scope of this application. In this way, this application is intended to cover these modifications and variations of this application provided that they fall within the scope of the claims of this application and their equivalent technologies.

What is claimed is:

1. A key management method, comprising:
receiving, by a first radio access network (RAN) device, a key parameter and an identifier of a target terminal device sent by a first terminal device;
performing at least one of encryption or decryption on transmission data related to communication between the first terminal device and the target terminal device based on the key parameter; and
sending, by the first RAN device, the key parameter and an identifier of the first terminal device to the target terminal device.

2. The method according to claim 1, wherein the target terminal device is located in a coverage area of the first RAN device.

3. The method according to claim 1, wherein the target terminal device is located in a coverage area of a second RAN device; and
sending, by the first RAN device, the key parameter and the identifier of the first terminal device to the target terminal device comprises sending, by the first RAN device, the key parameter and the identifier of the first terminal device to the target terminal device using the second RAN device.

4. The method according to claim 1, wherein the first terminal device communicates with the first RAN device using a first protocol stack, the target terminal device communicates with the first RAN device using the first protocol stack, and an end-to-end second protocol stack exists between the first terminal device and the target terminal device; and
wherein the first protocol stack comprises a physical (PHY) layer, a media access control (MAC) layer, and a radio link control (RLC) layer, and wherein the second protocol stack comprises a packet data convergence protocol (PDCP) layer, a service data adaptation protocol (SDAP) layer, an RLC layer, and a MAC layer.

5. The method according to claim 1, wherein the key parameter is a parameter required for the first terminal device and the target terminal device to separately generate a session key.

6. The method according to claim 1, wherein receiving, by the first RAN device, the key parameter and the identifier of the target terminal device that are sent by the first terminal device comprises:
receiving, by the first RAN device, first data sent by the first terminal device, wherein an encapsulation header encapsulated outside the first data comprises the key parameter and the identifier of the target terminal device.

7. The method according to claim 6, wherein sending, by the first RAN device, the key parameter and the identifier of the first terminal device to the target terminal device comprises:
sending, by the first RAN device, second data to the target terminal device, wherein an encapsulation header outside the second data comprises the key parameter and the identifier of the first terminal device.

8. The method according to claim 6, wherein sending, by the first RAN device, the key parameter and the identifier of the first terminal device to the target terminal device comprises:
sending, by the first RAN device, a data packet encapsulated by a general packet radio service tunneling protocol-user plane (GTP-U) to a second RAN device, wherein a packet header of the data packet encapsulated by the GTP-U carries the key parameter, the identifier of the first terminal device, and the identifier of the target terminal device, and wherein the data packet encapsulated by the GTP-U comprises the first data; and
sending the key parameter and the identifier of the first terminal device to the target terminal device using the second RAN device.

9. The method according to claim 1, wherein the identifier of the target terminal device comprises a first identifier of a second terminal device; and
wherein, before sending, by the first RAN device, the key parameter and the identifier of the first terminal device to the target terminal device, the method further comprises:
determining a second identifier of the second terminal device based on the first identifier of the second terminal device, wherein the first identifier comprises a device identifier, and the second identifier comprises a cell radio network temporary identifier C-RNTI; and
wherein sending, by the first RAN device, the key parameter and the identifier of the first terminal device to the target terminal device comprises:
sending, by the first RAN device, the key parameter and the identifier of the first terminal device to the second terminal device based on the second identifier of the second terminal device.

10. The method according to claim 1, wherein the identifier of the target terminal device comprises a group identifier of a terminal device group to which the first terminal device belongs; and
wherein sending, by the first RAN device, the key parameter and the identifier of the first terminal device to the target terminal device comprises:
sending, by the first RAN device, the key parameter and the identifier of the first terminal device to the terminal device group through a multicast channel, wherein the multicast channel corresponds to the terminal device group.

11. A key management method, comprising:
determining, by a first terminal device, a key parameter and an identifier of a target terminal device;
performing, by the first terminal device, at least one of encryption or decryption on transmission data related to communication between the first terminal device and the target terminal device based on the key parameter; and
sending, by the first terminal device, the key parameter and the identifier of the target terminal device to a first radio access network (RAN) device.

12. The method according to claim 11, wherein the target terminal device is located in a coverage area of the first RAN device.

13. The method according to claim 11, wherein the target terminal device is located in a coverage area of a second RAN device.

14. The method according to claim 11, wherein the first terminal device communicates with the first RAN device using a first protocol stack, the target terminal device communicates with the first RAN device using the first protocol stack, and an end-to-end second protocol stack exists between the first terminal device and the target terminal device; and
wherein the first protocol stack comprises a physical (PHY) layer, a media access control (MAC) layer, and a radio link control (RLC) layer, and wherein the second protocol stack comprises a packet data convergence protocol (PDCP) layer, a service data adaptation protocol (SDAP) layer, an RLC layer, and a MAC layer.

15. The method according to claim 11, wherein the key parameter is a parameter required for the first terminal device and the target terminal device to separately generate a session key.

16. The method according to claim 11, wherein sending, by the first terminal device, the key parameter and the identifier of the target terminal device to the first radio access network RAN device comprises:
sending, by the first terminal device, first data to the first radio access network RAN device, wherein an encapsulation header encapsulated outside the first data comprises the key parameter and the identifier of the target terminal device.

17. The method according to claim 11, wherein the identifier of the target terminal device comprises a first identifier of a second terminal device, and wherein the first identifier comprises a device identifier.

18. The method according to claim 11, wherein the identifier of the target terminal device comprises a group identifier of a terminal device group to which the first terminal device belongs.

19. A communication apparatus, comprising:
a processing module, configured to determine a key parameter and an identifier of a target terminal device, wherein the key parameter is used to perform at least one of encryption or decryption on transmission data related to communication between the communication apparatus and the target terminal device based on the key parameter; and
a sending module, configured to send the key parameter and the identifier of the target terminal device to a first radio access network (RAN) device.

20. The communication apparatus according to claim 19, wherein the target terminal device is located in a coverage area of the first RAN device or a second RAN device.
